(19) United States
(12) Patent Application Publication
(10) Pub. No.: US 2012/0191861 A1
(43) Pub. Date: Jul. 26, 2012

(54) Cardless Contact Information Exchange

(75) Inventors: Todd J. Bennett, Tracy, CA (US); John H. Brown, Dublin, CA (US); Amber D. Hom, Concord, CA (US)

(73) Assignee: CARDLESS TECHNOLOGIES, LLC, Pleasanton, CA (US)

(21) Appl. No.: 13/010,538

(22) Filed: Jan. 20, 2011

(51) Int. Cl. G06F 15/16

(52) U.S. Cl. 709/227

(57) ABSTRACT

In one embodiment, a method includes determining that a first user registered for an event. A first user identifier for the event is determined upon the first user registering for the event. The first user identifier is associated with the first user. A message is received from the first user. The message includes a second user identifier associated with a second user. The second user identifier is determined for the second user upon the second user registering for the event. A computing device automatically connects the second user and the first user using the first user identifier and the second user identifier.

### BACKGROUND

Particular embodiments generally relate to information exchange.

When two users meet, they often want to exchange contact information. One method of exchanging contact information is to exchange paper business cards. Paper business cards allow users to exchange information, but may be inconvenient. For example, if users save contact information electronically, each user has to manually enter in the other user's contact information. Also, sometimes users do not immediately enter the contact information into their contact database. In this case, the paper business cards may be forgotten, misplaced, or lost.

The users may also use an automatic information exchange application. For example, the users may use their cellular phones to connect over the air to automatically exchange contact information. However, there are restrictions that limit the usefulness of the application. For example, users with different types of phones often cannot exchange information due to incompatibility between phones. For example, different manufacturer's phones may not be able to communicate. Also, to exchange information, the users must have downloaded an application prior to meeting. Typically, the percentage of users that have both downloaded the application prior to meeting is low. Thus, the chances that both users have the same type of phone and have downloaded the application are low.

Assuming the phones are compatible, the user may download the application at that point if the users want to exchange information using the application. However, downloading the application and performing the required initial set up of the application is typically not feasible especially when users are at a networking event. At this point, the users may resort to other forms of exchanging information, such as using paper business cards.

### SUMMARY

In one embodiment, a method includes determining that a first user registered for an event. A first user identifier for the event is determined upon the first user registering for the event. The first event identifier is associated with the first user. A message is received from the first user. The message includes a second user identifier associated with a second user. The second user identifier is determined for the second user upon the second user registering for the event. A computing device automatically connects the second user and the first user using the first user identifier and the second user identifier.

In one embodiment, a non-transitory computer-readable storage medium containing instructions for controlling a computer system is provided. The computer system is operable to: determine that a first user registered for an event; determine a first user identifier for the event upon the first user registering for the event, the first user identifier associated with the first user; receive a message from the first user, the message including a second user identifier associated with a second user, the second user identifier determined for the second user upon the second user registering for the event; and automatically connect the second user and the first user using the first user identifier and the second user identifier.

In one embodiment, an apparatus including one or more computer processors and a computer-readable storage medium comprising instructions for controlling the one or more computer processors is provided. The one or more computer processor are operable to: determine that a first user registered for an event; determine a first user identifier for the event upon the first user registering for the event, the first user identifier associated with the first user; receive a message from the first user, the message including a second user identifier associated with a second user, the second user identifier determined for the second user upon the second user registering for the event; and automatically connect the second user and the first user using the first user identifier and the second user identifier.

The following detailed description and accompanying drawings provide a better understanding of the nature and advantages of the present invention.

### BRIEF DESCRIPTION OF THE DRAWINGS

FIG. 1 depicts a system for information exchange according to one embodiment.

FIG. 2 depicts a simplified flowchart of the registration process according to one embodiment.

FIG. 3 depicts a simplified flowchart of the process for exchanging contact information according to one embodiment.

FIG. 4 depicts a simplified flowchart of the information exchange process according to one embodiment.

FIG. 5 depicts a simplified flowchart of a method for sending requests to third-party sites according to one embodiment.

FIG. 6 depicts a more detailed example of a cardless contact server according to one embodiment.

FIG. 7 illustrates hardware of a special purpose computing machine configured with a cardless contact exchange system according to one embodiment.

### DETAILED DESCRIPTION

Described herein are techniques for an information exchange system. In the following description, for purposes of explanation, numerous examples and specific details are set forth in order to provide a thorough understanding of embodiments of the present invention. Particular embodiments as defined by the claims may include some or all of the features in these examples alone or in combination with other features described below, and may further include modifications and equivalents of the features and concepts described herein.

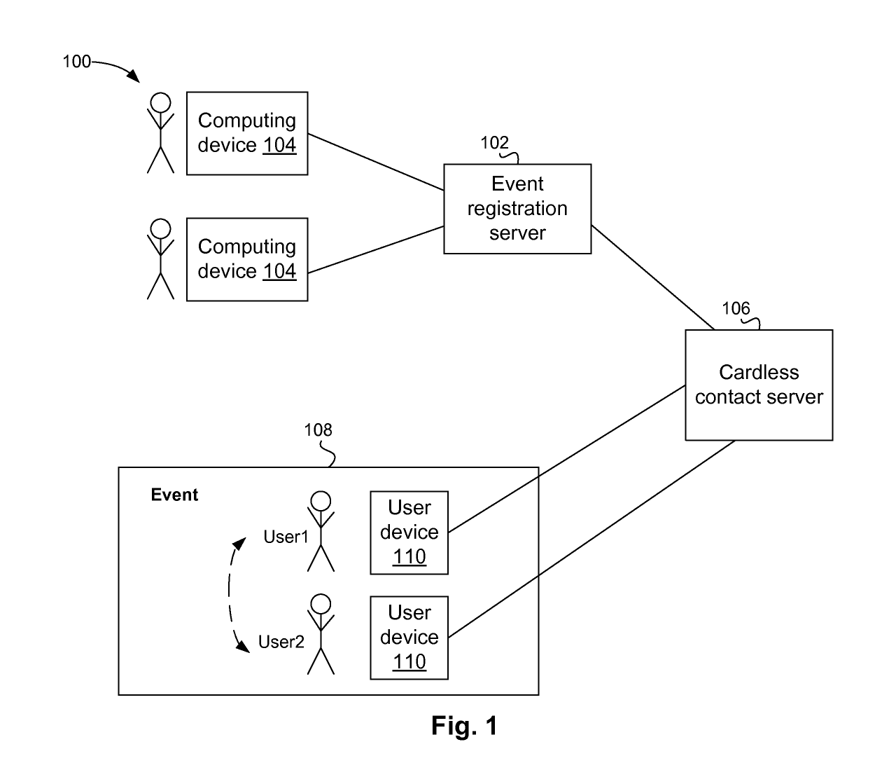

FIG. 1 depicts a system 100 for information exchange according to one embodiment. In one embodiment, system 100 provides a closed-looped system in which all users that meet at an event are able to exchange information. A closed-loop system may be where a triggering event, such as a user registering for the event, is needed to attend the event. The closed-loop system requires that all participants in attendance of a cardless contact powered event are pre-registered with the service and assigned or given the option to choose an identification (ID), such as an alphanumeric ID. This allows all attendees to exchange contact and social networking information by any communication to cardless contact server 106, such as texting or emailing their target contact's cardless contact ID to the service—without the worry of mismatched software, hardware, or exchange services. In one embodiment, particular embodiments leverage the registration to ensure that users are able to exchange information automatically when at an event without requiring the users to download an application and without regard to device type.

In one example, an event may be organized in advance. Events supported by particular embodiments are referred to as cardless contact powered events. Events may include networking events, presentations, conferences, or other gatherings. To utilize the cardless contact system, registration before the event or at the event is required. For example, a user may register for the event automatically by filling out their information using an event management service, such as an online website. In one example, users may connect to an event registration server 102 using computing devices 104 to register.

Event registration server 102 may register the users for the event. For example, computing devices 104 may be used to enter in user information, pay an event registration fee (the fee may not always be necessary), and record any other information that is needed. Event registration server 102 then registers the user for the event. For example, the user's registration information may be stored and it is noted that the user has registered for the event.

When users register for the event, if the event is a cardless contact powered event, the cardless contact service allows users when they are at the event to exchange information. The information may be exchanged without requiring each user to download an application and also is device agnostic. The information exchanged may be contact information. For example, contact information may be a name, address, email address, telephone number, or any other contact information. Other information may also be exchanged, such as pictures, documents, presentations, etc.

In one embodiment, event registration server 102 contacts cardless contact server 106. Information about the user may be sent to cardless contact server 106, such as the user's name and contact information. In one embodiment, for privacy reasons, a user may need to approve the use of the cardless contact service to have contact information exchanged; cardless contact server 106 is used to generate a user identifier for each user who has registered for the event. The user identifier is generated and the user is asked to approve the use of the service and also to create a cardless contact profile. If the user already has a cardless contact profile, then the user does not need be asked again to approve and create a profile and the user identifier may not be generated again for this event. In some embodiments, the same user identifier may be used in multiple events. However, in other embodiments, new user identifiers may be generated for each event. In both cases, user identifiers are assigned to all users registering for the event.

The situation where the user has not approved the cardless contact service is addressed below, but it is assumed that the users who have registered have approved the service. Each event has a unique event identifier that is associated with the user identifier for each user. The user identifier is a universal identifier for the user to be used over multiple events, such as the user's telephone, e-mail address, or username. The event identifier identifies the user's presence at the specific event and is used to associate historical contact exchange information.

The event identifier may be generated for a specific event. When users register for an event, the user identifiers for the users are associated with the event identifier for the event. For example, the user identifiers are attached to the event identifier in a database. As will be discussed in more detail below, users are allowed to exchange contact information if they have registered for the same event, which means their user identifiers have been associated with the same event identifier.

At 108, when the users are at the event, the user identifier is provided to each user. The user identifier may be provided to each user in different ways. Cardless contact server 106 may pass the user identifiers that were generated for the users back to event registration server 102. The user identifiers are then provided to the users at the event. For example, each user may be issued a name tag that includes the user's identifier on it. Also, users may have received the user identifier beforehand, such as via email, text message.

When the users want to exchange contact information, a first user (user1) may send a message to cardless contact server 106 with a second user's (user2) identifier. To exchange information, one user may send the user identifier to have information for both users exchanged between the two. Also, both users may send the user identifier, but this may not be necessary. Cardless Contact server 106 then facilitates connecting the first user and the second user. For example, automatic exchange of contact information between the first user and the second user is performed, the process of which will be described in more detail below.

The message sent to cardless contact server 106 may be in different forms. For example, a text message may be sent to a cardless contact server contact address, such as a telephone number. Also, different forms of communication may be used, such as e-mail, a voice telephone call, multimedia messaging service (MMS), etc. In one embodiment, any form of a message may be used as long as the message is received at cardless contact server 106 and can be interpreted by cardless contact server 106.

The type of user device 110 that is used to send the message may also vary. For example, as long as a device can contact cardless contact server 106, that device can be used. In one example, any cellular phone that can send text messages may be used. Accordingly, this alleviates the problem of users not being able to exchange contact information unless they have specifically downloaded an application or have a specific type of device. As long as users can contact cardless contact server 106 and both parties have user identifiers, users may be able to exchange contact information.

After sending the message with the user identifier for the other user, cardless contact server 106 uses the user identifier to identify the other user. Then, cardless contact server 106 can facilitate exchanging contact information between the first user and the second user. This process will be described in more detail below.

Additionally, as will be discussed in more detail below, cardless contact server 106 may automatically send requests to third-party sites. Third party sites include social media sites, such as Facebook, LinkedIn, and Twitter. Also, other third-party sites may include electronic address books, such as an Outlook™ address book, and contact information is synchronized with the electronic address book. This process will be described in more detail below.

At the end of the day or when the event ends, cardless contact server 106 may send a summary of the connections that a user has connected with. For example, the summary may list the contacts and additional details about the contacts. This allows a user to quickly know the connections made at an event and also receive additional information about the connections.

Because users need to register for the event to attend the event, the percentage of users that can exchange information is high. In one embodiment, everybody at the event can exchange information because they have all been assigned user identifiers when the users register, and the user identifier (and a way to message cardless contact server 106) is what is needed to exchange contact information. This provides a closed-loop system where all users at the event are capable of exchanging contact information immediately. By having the event identifier be used for only this event, the user's contacts may be organized by event. Further, the closed-loop system allows users to exchange contact information without regard to the devices they are using because communicating the user identifiers to cardless contact server 106 does not depend on device type.

The following will describe processes of particular embodiments in more detail. For example, registration, information exchange, and third party site connection processes will be described.

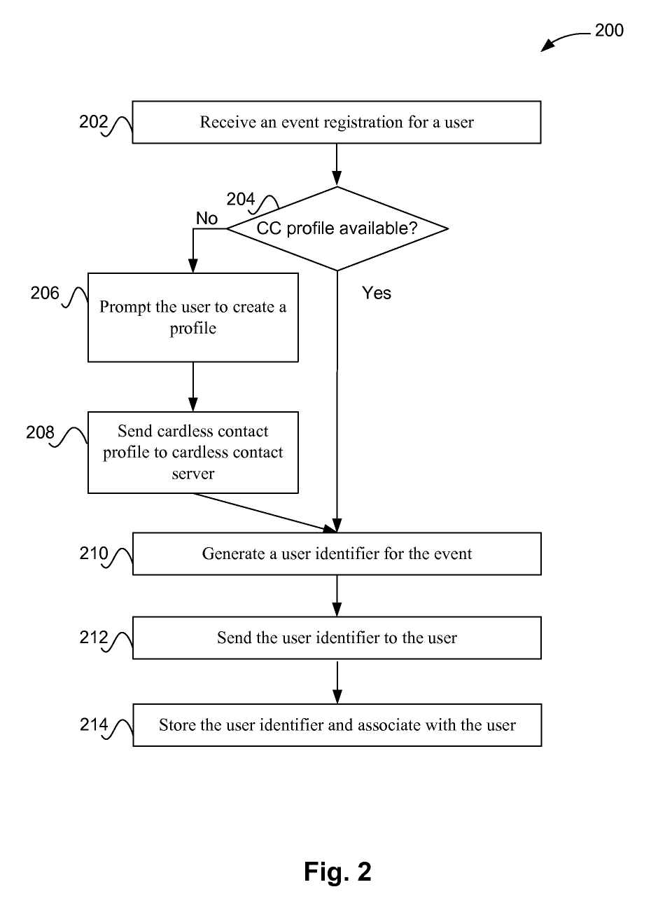

FIG. 2 depicts a simplified flowchart 200 of the registration process according to one embodiment. At 202, event registration server 102 receives an event registration for a user. The event registration may be performed using different methods. For example, an event management website may be used to process the registration.

The event registration involves receiving registration information from the user for the event. The registration information may be information that is used to identify the user. For example, a user's name, contact information (e.g., email, address, etc.), and login ID may be received.

At 204, event registration server 102 determines if a cardless contact (CC) profile is available for the user. For example, event registration server 102 may communicate with cardless contact server 106 to determine if the user has previously created a cardless contact profile. The cardless contact profile may be different from a profile being maintained by the event management website. Also, the profile may be created automatically using the registration information received from the user for the event.

If the user does not have a cardless contact profile, at 206, event registration server 102 (or cardless contact server 106) may prompt the user to create a profile. For discussion purposes, at 208, it is assumed the user creates a cardless contact profile and the cardless contact profile is sent to cardless contact server 106. It is possible that the user may not create a cardless contact profile at this time. In this case, the user identifier may be generated for the user. However, the contact information exchange will not happen until the user approves the exchange and/or creates a cardless contact profile.

After the cardless contact profile is created or if the user previously had a cardless contact profile, at 210, an event identifier for the event is associated with the user identifier. The event identifier may be generated by event registration server 102 or cardless contact server 106. For example, a plug-in module at event registration server 102 may generate the event identifier. Also, event registration server 102 may communicate with cardless contact server 106 to have the event identifier generated. The event identifier is uniquely associated with the single event. The event identifier may be generated once and looked up thereafter. For example, when an event is created and before anyone registers, an event identifier may be generated. The event identifier may then be retrieved when a user registers.

At 212, the user identifier may be sent to the user; however, this step is not necessary as the user may be provided the user identifier at the event. For example, the user identifier may be displayed for a user to view, e-mailed to the user, sent in a text message, or sent to the user in any other methods. The sending of the user identifier may also not be performed; rather, the user identifier is distributed to the user at the event as will be discussed below.

At 214, the event identifier is stored and associated with the user identifier. For example, cardless contact server 106 may store the event identifier with the user identifier in an event database. This provides a central database in which user identifiers may be stored for the event.

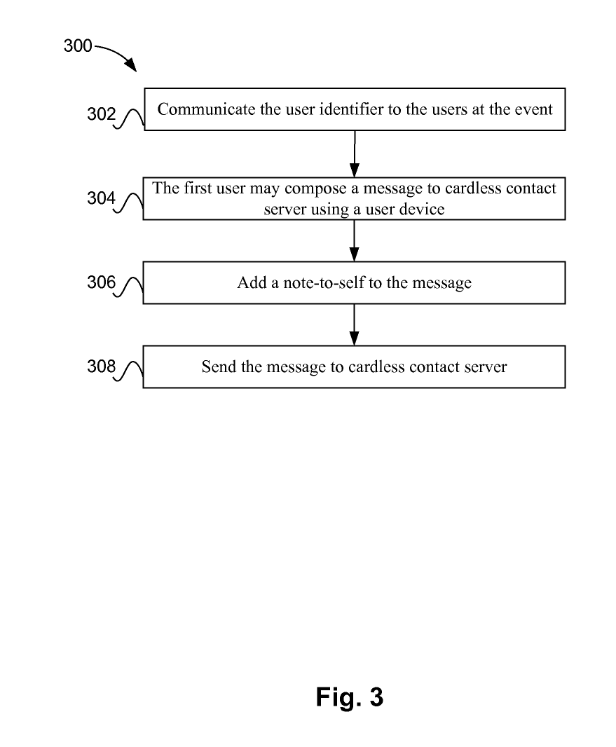

After event registration, the user may attend the event. FIG. 3 depicts a simplified flowchart 300 of the process for exchanging contact information according to one embodiment. This process may be performed when users are attending the event. At 302, the user identifier is communicated to the users at the event. In one embodiment, the user identifier is communicated to the user before or as the user arrives at the event so it can be used by the user while at the event. For example, users may typically be given a nametag when arriving to an event. The nametag may be printed with the user identifier on the name tag. Also, the user identifier may be manually written on the nametag. Other methods of communication may also be used, such as sending the user a text message or e-mail when/before the user arrives at the event.

In some cases, users may attend an event without pre-registering. In one embodiment, the users may be registered with cardless contact server 106 when they arrive. If the user already has a cardless contact profile, then a username, such as a user's cellular phone number, may be used to determine the user's cardless contact profile. A user identifier may then be generated. Also, if the user does not have a cardless contact profile, the user may register at that time. For example, a cardless contact profile may be created with a minimum amount of information. The user may then complete the cardless contact profile at a later time.

While at the event, a first user and a second user may meet each other and want to exchange contact information. At 304, the first user (user1) may compose a message to cardless contact server 106 using user device 110. The message includes the second user's (user2) user identifier and is addressed to cardless contact server 106. For example, the user may compose a text message that includes the second user's user identifier. As discussed above, any type of user device 110 may be used and different formats of messages may also be used.

At 306, a note-to-self may be added to the text message. For example, the note-to-self may be any information the user wants to add to the second user's contact information. The note-to-self may be used by the user to remember who the second user is or note any interesting details about the second user.

At 308, the message is sent to cardless contact server 106. For example, the user may send the text message to cardless contact server 106.

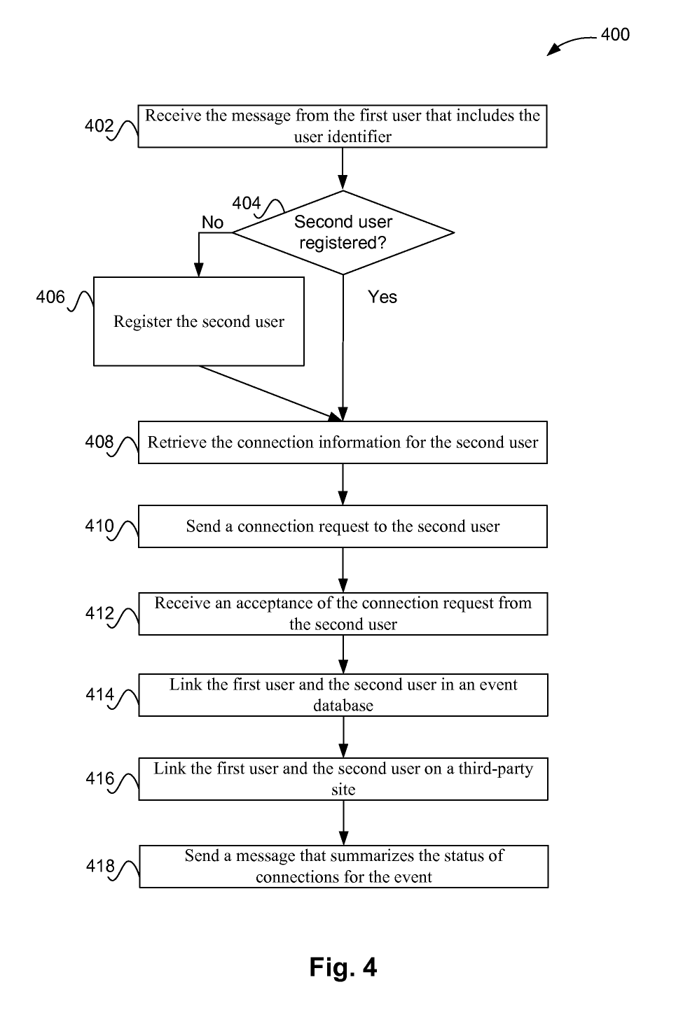

After receiving the message from the first user, cardless contract server 106 facilitates the information exchange. FIG. 4 depicts a simplified flowchart 400 of the information exchange process according to one embodiment. At 402, cardless contact server 106 receives the message from the first user that includes the user identifier. At 404, cardless contact server 106 determines if the user identifier is associated with a registered user (e.g., the second user).

If the second user is not registered, the process continues to register the second user at 406. For example, cardless contact server 106 contacts the second user with a request to register. The user may then enter registration information. For example, the user may reply in a text message with the registration information. Also, other methods may be used, such as the user may log in to a website and enter registration information into the website. Cardless contact server 106 may store the registration information and create a cardless contact profile for the second user. The registration process may occur in real-time when the second user receives the registration request during the event or may occur after the event. If the user does not create a cardless contact profile, the users are able to exchange information, such as basic pre-populated information from the registration, such as name, email, etc. However, any enhanced information from the cardless contact profile, such as third part sites, pictures, etc., may not be exchanged.

Assuming the second user registers for the cardless contact service or is already registered, at 408, cardless contact server 106 retrieves the contact information for the second user. At 410, cardless contact server 106 sends a connection request to the second user. The connection request may be sent using different methods, such as by a text message, an e-mail, or other methods. The connection request may be a request asking the second user approve the connection request from the first user. In other embodiments, the second user may set preferences such that connection requests may be automatically approved. For example, if a connection request is received during the time the event is going on, then the connection request may be automatically approved.

In this situation, cardless contact server 106 may verify that both the first user and the second user have registered for the event. For example, when the user identifier for the second user is received from the first user, cardless contact server 106 may identify the first user from the user's message. For example, a phone number or other identifying information (e.g., username, email address) may be used to identify the first user. Then, an event identifier is determined. For example, an event identifier that has been associated with the user identifier for the first user is looked up. The look up may retrieve a list of event identifiers associated with the user identifier for the first user. Also, other information may be used to further define which event the user is attending, such as a time period may be used to either determine that the user is at a certain event (assuming the message was sent while the first user was at the event). Also, a list of events within a certain time period (e.g., the last month) may be used. This is assuming that users will connect within a reasonable period of meeting each other and exchanging user identifiers.

The event identifier (or list) that is determined is then used to determine if the second user has registered for the same event. For example, cardless contact server 106 determines if the event identifier has been associated with the user identifier for the second user. If a list is being used, then the list for the first user is compared with a list of event identifiers associated with the second user. In one embodiment, a first user is only allowed to connect with a second user if each of the user identifiers for the first user and the second user has been associated with the same event identifier.

At 412, cardless contact server 106 receives an acceptance of the connection request from the second user. For example, the second user may reply to a text message to accept the connection request, log on to a webpage to accept the connection request, or accept the connection request through other methods. It is assumed the second user accepts the connection request. However, if the second user rejects the connection request, then the process ends and does not connect the first user and the second user.

At 414, cardless contact server 106 links the first user and the second user in an event database. For example, information may be stored to indicate that the first user and the second user have exchanged contact information. In one example, a flag or key may be set in the event database to indicate the first user and second user have requested and approved the exchange of contact information.

At 416, the first user and the second user may be linked on a third-party site. As will be described in more detail below, requests may be sent to other sites that link the first user and the second user, such as Facebook, LinkedIn, Twitter, and other sites. Also, electronic address books may be synced.

At 418, a message is sent that summarizes the status of connections for the event. For example, at the end of the day or when the event ends, a message that summarizes the contacts in which contact information was exchanged is sent. This message may also include other information for the contacts, such as information from the cardless contact profile of the second user and other information for third-party sites. An executable link may be provided to the other information, such as a link to a Facebook profile. This allows the users to quickly see who they connected with at the event.

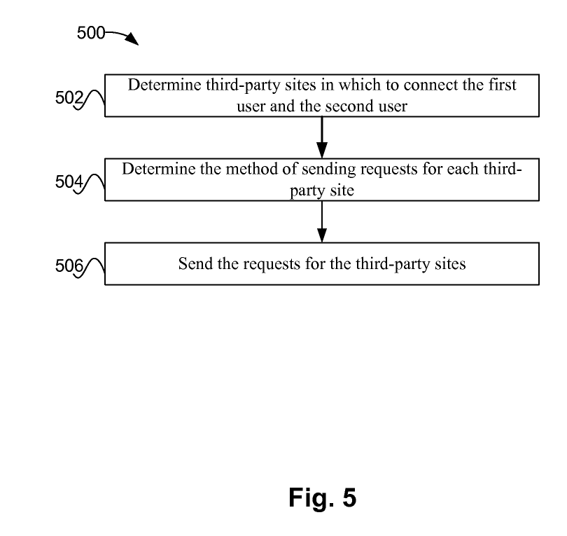

As discussed above, after exchanging contact information between the first and second users, particular embodiments may facilitate requests to third-party sites. FIG. 5 depicts a simplified flowchart 500 of a method for sending requests to third-party sites according to one embodiment.

At 502, cardless contact server 106 determines third-party sites in which to connect the first user and the second user. For example, third-party sites may include social media websites such as LinkedIn, Facebook, Twitter, or other media sites. Additionally, third party sites also include e-mail address books, electronic address books, or other web-based address books.

At 504, cardless contact server 106 determines the method of sending requests for each third-party site. At 506, the requests for the third-party sites are sent. For example, each third-party site may have different ways in which to connect the first user and the second user. In one example, different application programmer interfaces (APIs) may be used to connect to different third-party sites. In one example, a LinkedIn API may be used to send friend requests to LinkedIn or a friend request for Facebook using the Facebook API may be sent. In Twitter, a user may be able to follow another user without sending a friend request. In this case, cardless contact server 106 may follow the second user in Twitter for the first user, and vice versa.

Additionally, the contact information for the first user and the second user may be stored in each other's address books. For example, a virtual card (Vcard), which includes contact information, may be sent. This may exchange Vcards between the first user and the second user. In another example, if an Outlook™ contact list is used, then cardless contact server 106 may sync the contact list in Outlook™ for the first user and the second user. In this case, a plugin to Outlook™ may communicate with an email server to sync the contact information for the second user in Outlook™ for the first user, and vice versa. For example, the plugin may search the address book and determine if an entry for the other user is present. If so, any additional information may be added. If not, a new entry is added.

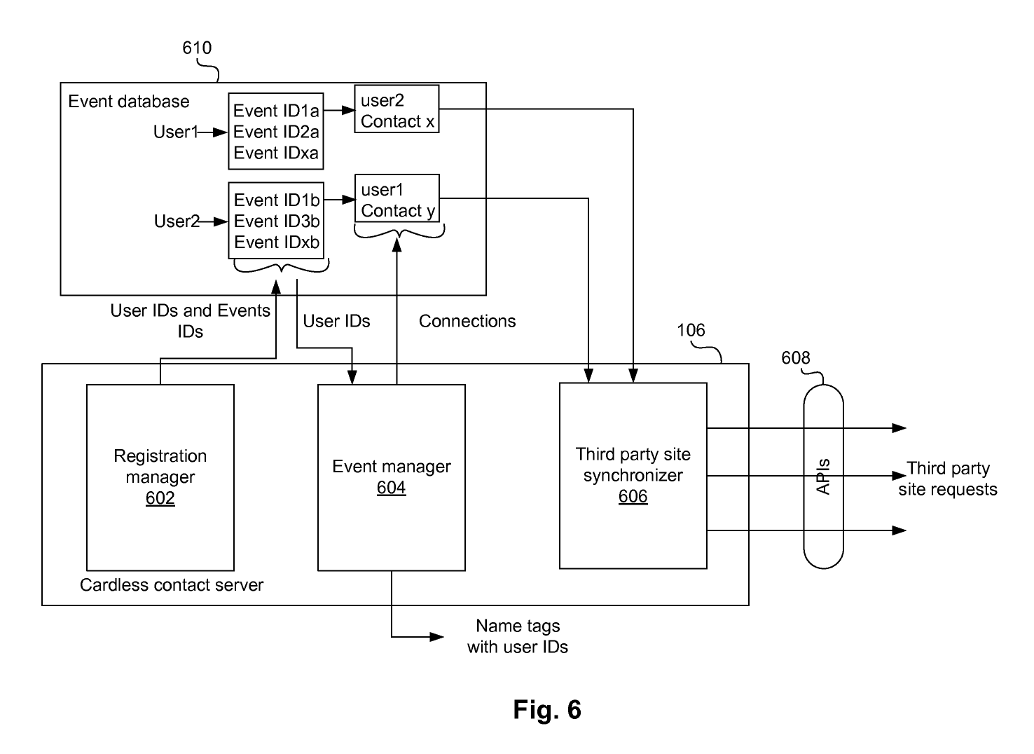

FIG. 6 depicts a more detailed example of cardless contact server 106 according to one embodiment. An event database 610 is used to store information for contact exchange. A registration manager 602 is used to store user identifiers for the various users. Each user identifier is associated with event identifiers for events that the users have participated in. For example, each event in which a user participates is associated with a unique event identifier.

In one example, user1 may have attended x events and received the user identifiers ID1a, ID2a, and IDxa. User2 may have received the user identifiers ID1b, ID3b, and IDxb. The format of the user identifiers may vary, but generally, user identifiers may be correlated by event and also by user. Thus, when at an event, an event manager 604 determines the user identifier for the user from event database 610 (e.g., for printing on a nametag).

Also, event manager 604 is used to store contact information for other users that each user connected with during the event. Thus, for each user ID, a number of contacts are stored. For example, user1 has connected with user2 and contact x and user 2 has connected with user1 and contact y.

Event manager 604 may also send summaries to users. For example, a record of all the events a user has participated in and the contacts that were connected with during the events may be stored in database 610. Event summaries may then be sent to a user. For example, the user may receive an event summary for a single event or may receive event summaries for a range of dates or multiple events.

A third-party synchronizer 606 is then used to synchronize with third-party sites. For example, third-party synchronizer 606 communicates through third-party APIs 608 to connect users.

Accordingly, particular embodiments provide many advantages. For example, because of the closed-loop structure, a high percentage of users may participate in the cardless contact information exchange system. Thus, when the user is at an event and meets another user, the users can exchange contact information without having to download any applications or have a particular type of device. This is because user identifiers have been assigned to all users that have registered for the event.

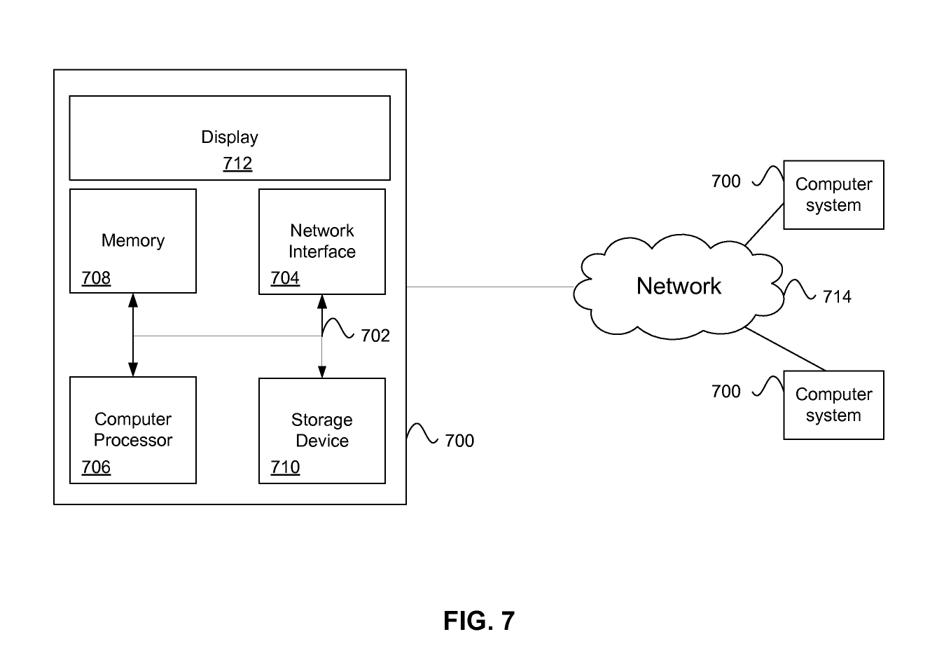

FIG. 7 illustrates an example of a special purpose computer system 700 configured with a cardless contact exchange system according to one embodiment. Computer system 700 includes a bus 702, network interface 704, a computer processor 706, a memory 708, a storage device 710, and a display 712.

Bus 702 may be a communication mechanism for communicating information.

Computer processor 704 may execute computer programs stored in memory 708 or storage device 708. Any suitable programming language can be used to implement the routines of particular embodiments including C, C++, Java, assembly language, etc. Different programming techniques can be employed such as procedural or object oriented. The routines can execute on a single computer system 700 or multiple computer systems 700. Further, multiple processors 706 may be used.

Memory 708 may store instructions, such as source code or binary code, for performing the techniques described above. Memory 708 may also be used for storing variables or other intermediate information during execution of instructions to be executed by processor 706. Examples of memory 708 include random access memory (RAM), read only memory (ROM), or both.

Storage device 710 may also store instructions, such as source code or binary code, for performing the techniques described above. Storage device 710 may additionally store data used and manipulated by computer processor 706. For example, storage device 710 may be a database that is accessed by computer system 700. Other examples of storage device 710 include random access memory (RAM), read only memory (ROM), a hard drive, a magnetic disk, an optical disk, a CD-ROM, a DVD, a flash memory, a USB memory card, or any other medium from which a computer can read.

Memory 708 or storage device 710 may be an example of a non-transitory computer-readable storage medium for use by or in connection with computer system 700. The computer-readable storage medium contains instructions for controlling a computer system to be operable to perform functions described by particular embodiments. The instructions, when executed by one or more computer processors, may be operable to perform that which is described in particular embodiments.

Computer system 700 includes a display 712 for displaying information to a computer user. Display 712 may display a user interface used by a user to interact with computer system 700.

Computer system 700 also includes a network interface 704 to provide data communication connection over a network, such as a local area network (LAN) or wide area network (WAN). Wireless networks may also be used. In any such implementation, network interface 704 sends and receives electrical, electromagnetic, or optical signals that carry digital data streams representing various types of information.

Computer system 700 can send and receive information through network interface 704 across a network 714, which may be an Intranet or the Internet. Computer system 700 may interact with other computer systems 700 through network 714. In some examples, client-server communications occur through network 714. Also, implementations of particular embodiments may be distributed across computer systems 700 through network 714.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

The above description illustrates various embodiments of the present invention along with examples of how aspects of the present invention may be implemented. The above examples and embodiments should not be deemed to be the only embodiments, and are presented to illustrate the flexibility and advantages of the present invention as defined by the following claims. Based on the above disclosure and the following claims, other arrangements, embodiments, implementations and equivalents may be employed without departing from the scope of the invention as defined by the claims.

What is claimed is:

1. A method comprising:
determining that a first user registered for an event;
determining a first user identifier for the event upon the first user registering for the event, the first user identifier associated with the first user;
receiving a message from the first user, the message including a second user identifier associated with a second user, the second user identifier determined for the second user upon the second user registering for the event; and
automatically, by a computing device, connecting the second user and the first user using the first user identifier and the second user identifier.

2. The method of claim 1, further comprising:
sending a connection request to the second user upon receiving the message; and
receiving a confirmation from the second user to accept the connection request, wherein the second user and the first user are connected upon receiving the confirmation.

3. The method of claim 1, further comprising:
determining one or more first event identifiers associated with the first user identifier;
determining one or more second event identifiers associated with the second user identifier; and
determining if an event identifier matches in the one or more first event identifiers and the one or more second event identifiers,
wherein connecting the second user with the first user is allowed if the match is determined.

4. The method of claim 1, further comprising:
receiving first contact information from the first user;
receiving second contact information from the second user; and
exchanging the first contact information and the second contact information between the first user and the second user to connect the first user and the second user.

5. The method of claim 1, wherein the message is sent using a device, wherein the first user and the second user are connected regardless of a device type.

6. The method of claim 1, wherein the message includes a note entered by the first user, the method further comprising:
storing, for the first user, the note with contact information for the second user.

7. The method of claim 1, further comprising sending a request to a third party site in which the second user is a member to request a connection with the second user in the third party site.

8. The method of claim 7, further comprising:
determining a method in which to request the connection to the third party site; and
sending the request using the method such that the request is automatically performed upon connecting the first user and the second user.

9. The method of claim 1, further comprising storing contact information for the second user with a third party contact list associated with the first user.

10. The method of claim 1, further comprising sending a summary message to the first user summarizing connections made during the event, wherein contact information for the second user is included in the summary message.

11. The method of claim 1, further comprising:
storing the first user identifier for the first user for the event;
storing the second user identifier for the second user for the event;
retrieving the first user identifier to communicate the first user identifier to the first user while the first user is at the event; and
retrieving the second user identifier to communicate the second user identifier to the second user while the second user is at the event.

12. The method of claim 1, wherein connecting comprises:
storing a second user identifier associated with the second user with the first user identifier; and
storing a first user identifier associated with the first user with the first user identifier.

13. A non-transitory computer-readable storage medium containing instructions for controlling a computer system to be operable to:
determine that a first user registered for an event;
determine a first user identifier for the event upon the first user registering for the event, the first user identifier associated with the first user;
receive a message from the first user, the message including a second user identifier associated with a second user, the second user identifier determined for the second user upon the second user registering for the event; and
automatically connect the second user and the first user using the first user identifier and the second user identifier.

14. The computer-readable storage medium of claim 13, further operable to:
send a connection request to the second user upon receiving the message; and
receive a confirmation from the second user to accept the connection request, wherein the second user and the first user are connected upon receiving the confirmation.

15. The computer-readable storage medium of claim 13, further operable to:
determine one or more first event identifiers associated with the first user identifier;
determine one or more second event identifiers associated with the second user identifier; and
determine if an event identifier matches in the one or more first event identifiers and the one or more second event identifiers,
wherein connecting the second user with the first user is allowed if the match is determined.

16. The computer-readable storage medium of claim 13, further operable to:
receive first contact information from the first user;
receive second contact information from the second user; and
exchange the first contact information and the second contact information between the first user and the second user to connect the first user and the second user.

17. The computer-readable storage medium of claim 13, wherein the message is sent using a device, wherein the first user and the second user are connected regardless of a device type.

18. The computer-readable storage medium of claim 13, further operable to send a request to a third party site in which the second user is a member to request a connection with the second user in the third party site.

19. The computer-readable storage medium of claim 13, further operable to store contact information for the second user with a third party contact list associated with the first user.

20. An apparatus comprising:
one or more computer processors; and
a computer-readable storage medium comprising instructions for controlling the one or more computer processors to be operable to:
determine that a first user registered for an event;
determine a first user identifier for the event upon the first user registering for the event, the first user identifier associated with the first user;
receive a message from the first user, the message including a second user identifier associated with a second user, the second user identifier determined for the second user upon the second user registering for the event; and
automatically connect the second user and the first user using the first user identifier and the second user identifier.
